(19) United States
(12) Patent Application Publication
(10) Pub. No.: US 2025/0132508 A1
(43) Pub. Date: Apr. 24, 2025

(54) TERMINAL-EQUIPPED ELECTRIC WIRE AND JOINING METHOD THEREOF

(71) Applicant: Yazaki Corporation, Tokyo (JP)

(72) Inventors: Tomoaki HAYAKAWA, Shizuoka (JP); Hiroki Kitagawa, Shizuoka (JP); Shotaro Shibata, Shizuoka (JP); Motohide Sato, Shizuoka (JP); Kengo Aoshima, Shizuoka (JP); Narumi Suzuki, Shizuoka (JP); Takashi Ishihara, Shizuoka (JP)

(73) Assignee: Yazaki Corporation, Tokyo (JP)

(21) Appl. No.: 18/916,045

(22) Filed: Oct. 15, 2024

(30) Foreign Application Priority Data
Oct. 18, 2023 (JP) 2023-179525

(51) Int. Cl. H01R 4/02; H01R 43/02

(52) U.S. Cl. CPC H01R 4/023; H01R 43/0207

(57) ABSTRACT

A terminal-equipped electric wire is formed by joining a terminal and a core wire exposed from an insulation sheath of an electric wire by method of ultrasonic joining, and the terminal includes a joining portion having a square shape or a round shape in plan view, to which a distal end portion of the core wire is joined. When the joining portion has a square shape, a longitudinal direction of the electric wire is orthogonal to a longitudinal direction of the terminal.

### CROSS REFERENCE TO RELATED APPLICATIONS

The present application is based on, and claims priority from the prior Japanese Patent Application No. 2023-179525, filed on Oct. 18, 2023, the entire contents of which are incorporated herein by reference.

### TECHNICAL FIELD

The present disclosure relates to a terminal-equipped electric wire and a joining method of a terminal-equipped electric wire.

### BACKGROUND

For joining a terminal and an electric wire, there is a known method in which an insulation sheath of the electric wire is peeled off to expose a core wire which is made of a plurality of element wires, and an end of the exposed core wire is joined to the terminal by method of ultrasonic joining.

JP2015-135742 A discloses a terminal-equipped electric wire which is prepared by sandwiching an end of a core wire and a part of a terminal between an anvil and a horn, and performing ultrasonic joining by ultrasonic vibration of the horn.

### SUMMARY OF THE INVENTION

In a method disclosed in JP2015-135742 A, since the terminal and an electric wire are fixed by crimping when they are connected, an orientation of a longitudinal direction of the electric wire relative to a longitudinal direction of the terminal (hereinafter referred to as an electric wire extending direction) is limited. Therefore, when the electric wire extending direction is changed, it is necessary to newly prepare and arrange a terminal according to the electric wire extending direction, and complicated assembly was a problem.

The present disclosure has been made in view of the above-mentioned problem in such a related-art. An object of the present disclosure is to provide a terminal-equipped electric wire with enhanced degree of freedom in assembling due to non-limitation of an electric wire extending direction, and a joining method of the terminal-equipped electric wire.

An aspect of the present disclosure provides a terminal-equipped electric wire formed by joining a terminal and a core wire exposed from an insulation sheath of an electric wire by method of ultrasonic joining, in which the terminal includes a joining portion having a square shape or a round shape in plan view, to which a distal end portion of the core wire is joined, and when the joining portion has a square shape, a longitudinal direction of the electric wire is orthogonal to a longitudinal direction of the terminal.

Another aspect of the present disclosure provides a joining method of a terminal-equipped electric wire, including: joining a terminal and a core wire exposed from an insulation sheath of an electric wire by method of ultrasonic joining, in which the terminal includes a joining portion having a square shape or a round shape in plan view, the joining portion and a distal end portion of the core wire are joined, and when the joining portion has a square shape, joining is performed in a state where a longitudinal direction of the electric wire is orthogonal to a longitudinal direction of the terminal.

According to the present disclosure, it is possible to provide a terminal-equipped electric wire with enhanced degree of freedom in assembling due to non-limitation of an electric wire extending direction, and a joining method of the terminal-equipped electric wire.

### BRIEF DESCRIPTION OF DRAWINGS

FIG. 1 is a plan view illustrating an example of a terminal according to a first embodiment of the present disclosure.

FIG. 2 is a plan view illustrating an example of a terminal-equipped electric wire according to the first embodiment of the present disclosure.

FIG. 3 is an enlarged view of a joining portion of a terminal and an electric wire in FIG. 2.

FIG. 4 is a plan view illustrating a terminal-equipped electric wire when an electric wire extending direction is changed according to the first embodiment of the present disclosure.

FIG. 5 is a side view illustrating an example of the terminal-equipped electric wire according to the first embodiment of the present disclosure.

FIG. 6 is a side view illustrating an example of the terminal-equipped electric wire according to the first embodiment of the present disclosure.

FIG. 7 is a plan view illustrating an example of a terminal according to a second embodiment of the present disclosure.

FIG. 8 is a plan view illustrating a terminal-equipped electric wire when an electric wire extending direction is changed according to the second embodiment of the present disclosure.

### DETAILED DESCRIPTION OF THE INVENTION

A terminal-equipped electric wire and a joining method of a terminal-equipped electric wire according to embodiments of the present disclosure will be described in detail below with reference to the drawings. The dimensional ratios of the drawings are exaggerated for convenience of explanation and may differ from the actual ratio.

### First Embodiment

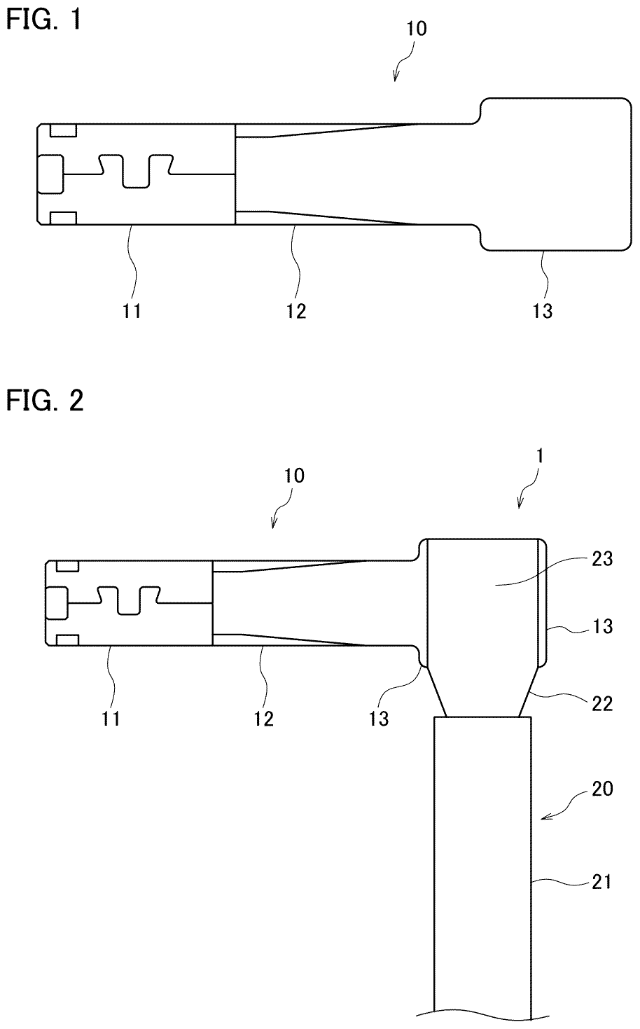

A terminal 10 of a terminal-equipped electric wire 1 is a female type. The terminal 10 has, on the left side in FIG. 1, an electrical connection portion 11 connected to a mating terminal (not shown). The electrical connection portion 11 has a box-like appearance and has a spring piece (not shown) engaged with the mating terminal therein. Further, a square shaped joining portion 13 to which an electric wire 20 is joined is disposed on the right side of the electrical connection portion 11 in FIG. 1 with a connection portion 12 therebetween.

As a material constituting the terminal 10, although it is possible to use highly conductive metal, it is possible to use at least one of copper, a copper alloy, stainless steel, tin-plated copper, a tin-plated copper alloy, or tin-plated stainless steel, for example. Further, at least one of gold-plated copper, a copper alloy, or stainless steel may be used, or at least one of silver-plated copper, a copper alloy, or stainless steel may be used.

As illustrated in FIG. 2, the terminal-equipped electric wire 1 is prepared by joining the terminal 10 and the electric wire 20 by method of ultrasonic joining. The electric wire 20 has a structure in which a core wire 22 formed of a plurality of element wires is covered with an insulation sheath 21.

As a material constituting the core wire 22, although it is possible to use highly conductive metal, copper, a copper alloy, aluminum, an aluminum alloy, or the like can be used, for example. The insulation sheath 21 on a distal end side of the electric wire 20 is peeled off to partially expose the core wire 22, and a distal end of the core wire 22 is a distal end portion 23 to be joined to the joining portion 13 of the terminal 10.

As a material of the insulation sheath 21 covering the core wire 22, a resin capable of ensuring electrical insulation can be used, for example, a resin containing polyvinyl chloride (PVC) as a main component or an olefin-based resin can be used. Specific examples of the olefin-based resin include polyethylene (PE), polypropylene (PP), ethylene copolymer, and propylene copolymer.

As described above, the terminal-equipped electric wire 1 is formed by joining the terminal 10 and the core wire 22 exposed from the insulation sheath 21 of the electric wire 20 by method of ultrasonic joining, and electrically connecting the core wire 22 and the terminal 10. The terminal 10 has the joining portion 13 to which the distal end portion 23 of the core wire 22 is joined.

Ultrasonic joining is a method in which due to an ultrasonic joining device applying ultrasonic vibration to metal, joining surfaces rub against each other, activated metal surfaces are exposed on the joining surfaces, and joining is performed in a solid phase state by plastic deformation due to pressurization. In a state where an anvil (not shown) and a horn (not shown) sandwich and pressurize the joining portion 13 and the distal end portion 23, ultrasonic joining is performed by ultrasonic vibration of the horn.

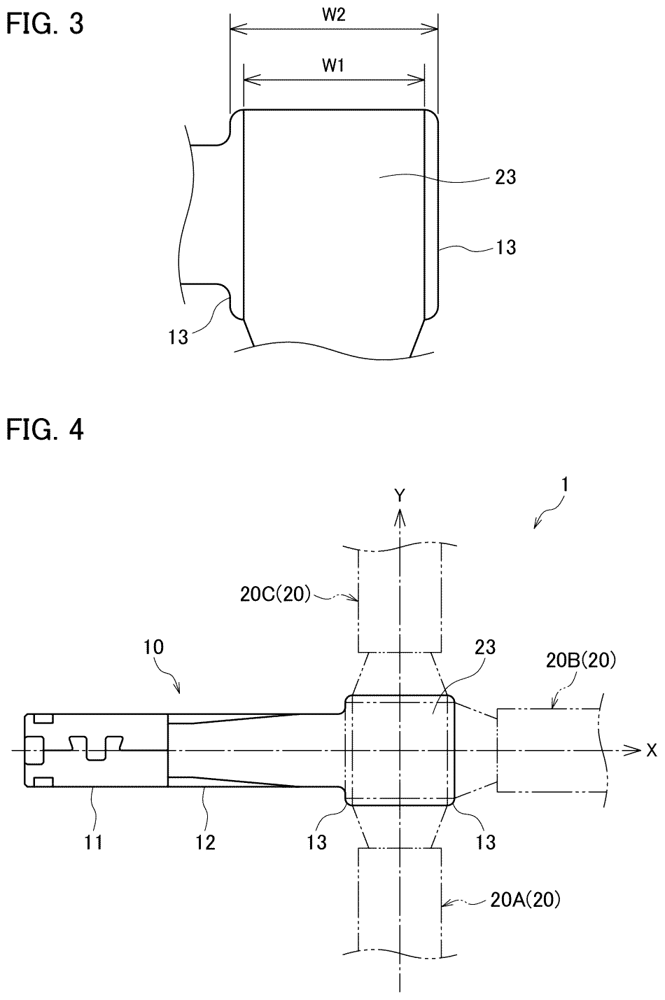

FIG. 3 is an enlarged view of the joining portion of the terminal 10 and the electric wire 20 in FIG. 2, and the distal end portion 23 of the core wire 22 is joined on the joining portion 13. The joining portion 13 has a square shape, and it is preferable that a joining width W1 of the core wire 22 is smaller than a width W2 of the joining portion 13. Due to the joining width W1 of the core wire 22 being smaller than the width W2 of the joining portion 13, it is possible to ensure pressing widths for pressing the terminal 10 with jigs on both sides of the distal end portion 23 on the joining portion 13, and this leads to an increase in the efficiency of a joining process. Specifically, as illustrated in FIG. 3, regions on the joining portion 13 which are formed between the joining width W1 of the core wire 22 and the width W2 of the joining portion 13 become the pressing widths for pressing the terminal 10 with jigs.

FIG. 4 is a plan view illustrating an example of the terminal-equipped electric wire 1. In FIG. 4, an X-axis is along a longitudinal direction of the terminal 10, an X-axis plus direction is a direction from the electrical connection portion 11 toward the joining portion 13, and an X-axis minus direction is a direction from the joining portion 13 toward the electrical connection portion 11. A Y-axis is an axis perpendicular to the X-axis, a Y-axis plus direction is a direction of 90 degrees clockwise from the terminal 10, and a Y-axis minus direction is a direction of 90 degrees counterclockwise from the terminal 10.

An extending direction of an electric wire 20A is in the Y-axis minus direction, and is orthogonal to the longitudinal direction of the terminal 10. Further, an extending direction of an electric wire 20B is in the X-axis plus direction, and the longitudinal direction of the terminal 10 and the electric wire extending direction are in the same direction. Still further, an extending direction of an electric wire 20C is in the Y-axis plus direction, and is orthogonal to the longitudinal direction of the terminal 10.

The joining portion 13 in the terminal-equipped electric wire according to the present embodiment has a square shape, and a longitudinal direction of the electric wire 20 is orthogonal to the longitudinal direction of the terminal 10. That is, the electric wire extending direction is orthogonal to the longitudinal direction of the terminal 10, and the electric wire 20 is located at a position of the electric wire 20A or the electric wire 20C in FIG. 4. As described above, if the joining width W1 of the core wire 22 is smaller than the width W2 of the joining portion 13, even if the electric wire extending direction is orthogonal to the longitudinal direction of the terminal 10, a pressing width for pressing the terminal 10 with jigs can be ensured.

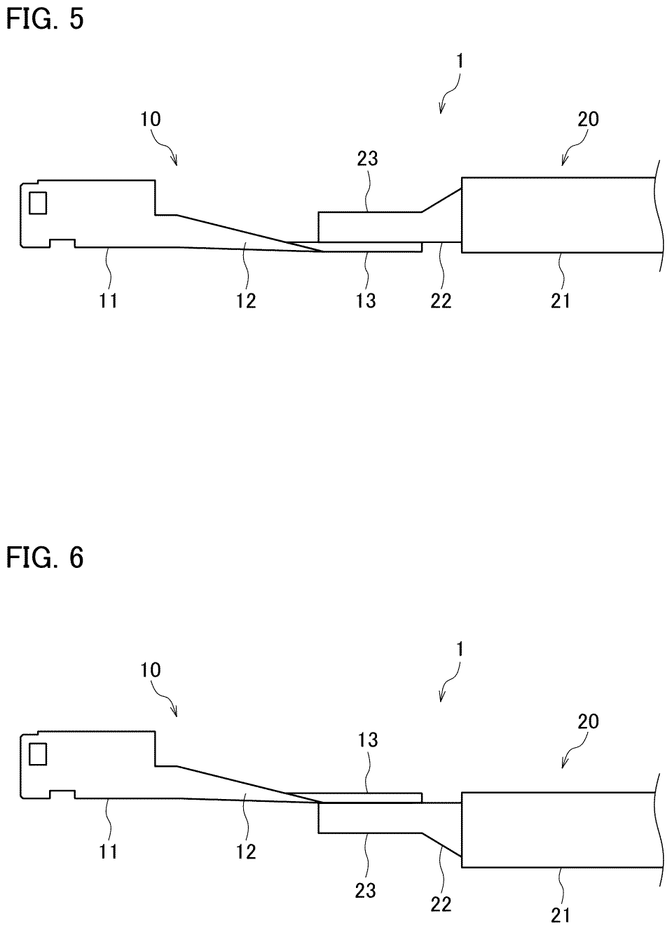

FIG. 5 is a side view when joining with the electric wire located at the position of the electric wire 20B is performed. Meanwhile, FIG. 6 is a side view when the distal end portion 23 of the core wire 22 is joined from a back surface of the joining portion 13, although the longitudinal direction of the terminal 10 and the electric wire extending direction are in the same direction as in FIG. 5. The back surface of the joining portion 13 is a surface opposite to a surface in a direction where the electrical connection portion 11 is formed, and is a lower surface in FIG. 5. Although FIG. 6 illustrates a case where the longitudinal direction of the terminal 10 and the electric wire extending direction are in the same direction, the electric wire extending direction may be orthogonal to the longitudinal direction of the terminal 10. In this way, the electric wire can be joined from either a front surface or the back surface of the joining portion 13.

As described above, the terminal-equipped electric wire of the present embodiment is the terminal-equipped electric wire 1 formed by joining the terminal 10 and the core wire 22 exposed from the insulation sheath 21 of the electric wire 20 by method of ultrasonic joining. The terminal 10 has the joining portion 13 with a square shape in plan view, to which the distal end portion 23 of the core wire 22 is joined, and the longitudinal direction of the electric wire 20 is orthogonal to the longitudinal direction of the terminal 10. Therefore, the terminal-equipped electric wire with enhanced degree of freedom in assembling can be obtained because the electric wire extending direction is not limited, and the design adapted to an internal shape of a connector becomes possible.

In a joining method of the terminal-equipped electric wire 1 according to the first embodiment, the terminal 10 and the core wire 22 exposed from the insulation sheath 21 of the electric wire 20 are joined by method of ultrasonic joining. The terminal 10 has the joining portion 13 which has a square shape in plan view, and the joining portion 13 and the distal end portion 23 of the core wire 22 are joined. Joining is performed in a state where the longitudinal direction of the electric wire 20 is orthogonal to the longitudinal direction of the terminal 10. Therefore, it is possible to provide the joining method of the terminal-equipped electric wire with enhanced degree of freedom in assembling because the electric wire extending direction is not limited.

### Second Embodiment

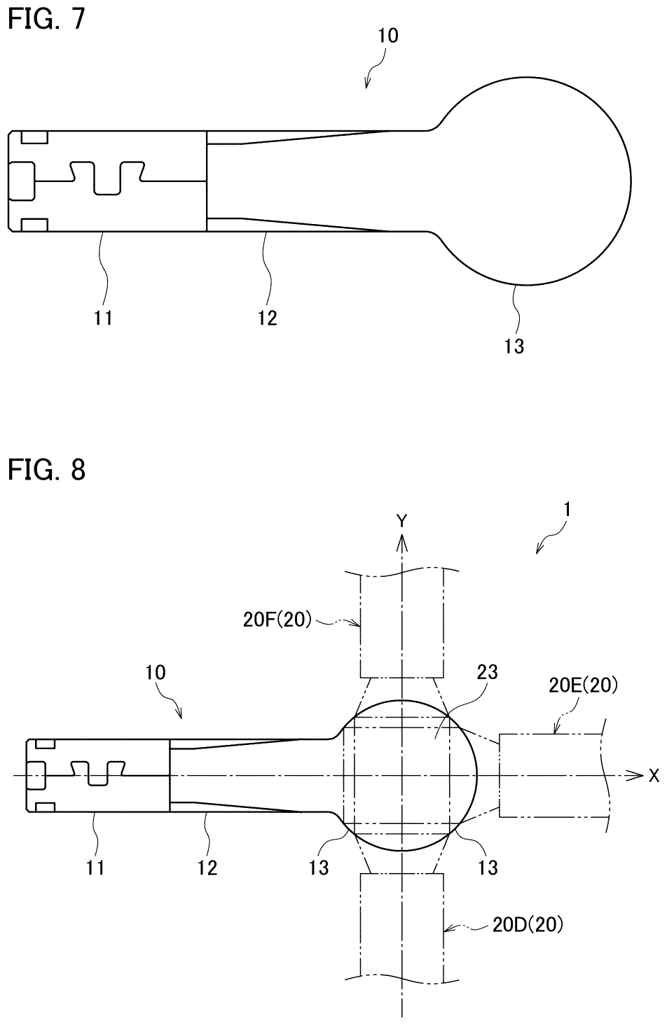

Next, a terminal-equipped electric wire according to a second embodiment will be described with reference to FIGS. 7 and 8. Descriptions of similar parts between the second embodiment and the first embodiment are omitted or simplified.

A joining portion 13 has a round shape as illustrated in FIG. 7. FIG. 8 is a plan view illustrating an example of a terminal-equipped electric wire 1. Similarly to FIG. 4, an X-axis is along a longitudinal direction of a terminal 10, and a Y-axis is an axis perpendicular to the X-axis. An extending direction of an electric wire 20D is in the Y-axis minus direction, and the electric wire extending direction is orthogonal to the longitudinal direction of the terminal 10. Further, an extending direction of an electric wire 20E is in the X-axis plus direction, and the longitudinal direction of the terminal 10 and the electric wire extending direction are in the same direction. Still further, an extending direction of an electric wire 20F is in the Y-axis plus direction, and the electric wire extending direction is orthogonal to the longitudinal direction of the terminal 10.

Since the joining portion 13 has a round shape, even if the electric wire extending direction is orthogonal to the longitudinal direction of the terminal 10 or both directions are in the same direction, it is possible to ensure a pressing width for pressing the terminal 10 with jigs on both sides of a distal end portion 23 on the joining portion 13. Specifically, as illustrated in FIG. 8, a region formed around the distal end portion 23 on the joining portion 13 is a pressing width for pressing the terminal 10 with jigs.

Since the joining portion 13 in the terminal-equipped electric wire of the present embodiment has a round shape, it is possible to ensure a pressing width for pressing the terminal 10 with jigs without being limited by the extending directions of the electric wire 20D, the electric wire 20E, and the electric wire 20F described above. That is, the electric wire extending direction may cross the longitudinal direction of the terminal 10. In FIG. 8, the electric wire extending direction may be in a direction toward the terminal 10 from a position of the electric wire 20D, that is, the electric wire extending direction may be in a direction sandwiched between the X-axis minus direction and the Y-axis minus direction, for example. Further, the electric wire extending direction may be in a direction toward a position of the electric wire 20E from the position of the electric wire 20D, that is, the electric wire extending direction may be in a direction sandwiched between the X-axis plus direction and the Y-axis minus direction. Still further, the electric wire extending direction may be in a direction toward the terminal 10 from a position of the electric wire 20F, that is, the electric wire extending direction may be in a direction sandwiched between the X-axis minus direction and the Y-axis plus direction. In addition, the electric wire extending direction may be in a direction toward the position of the electric wire 20E from the position of the electric wire 20F, that is, the electric wire extending direction may be in a direction sandwiched between the X-axis plus direction and the Y-axis plus direction.

In this way, since the joining portion 13 in the terminal-equipped electric wire of the present embodiment has a round shape, the electric wire extending direction is not limited, and the longitudinal direction of the electric wire 20 may be orthogonal to or cross the longitudinal direction of the terminal 10. Further, as in FIG. 6, the distal end portion 23 of a core wire 22 may be joined from a back surface of the joining portion 13.

As described above, the terminal-equipped electric wire of the present embodiment is the terminal-equipped electric wire 1 formed by joining the terminal 10 and the core wire 22 exposed from the insulation sheath 21 of the electric wire 20 by method of by ultrasonic joining. The terminal 10 has the joining portion 13 with a round shape in plan view, to which the distal end portion 23 of the core wire 22 is joined. The longitudinal direction of the electric wire 20 may cross the longitudinal direction of the terminal 10. Therefore, as in the first embodiment, the terminal-equipped electric wire with enhanced degree of freedom in assembling is obtained because the electric wire extending direction is not limited, and the design adapted to an internal shape of a connector becomes possible.

In a joining method of the terminal-equipped electric wire 1 of the second embodiment, the terminal 10 and the core wire 22 exposed from the insulation sheath 21 of the electric wire 20 are joined by method of ultrasonic joining. The terminal 10 has the joining portion 13 which has a round shape in plan view, and the joining portion 13 and the distal end portion 23 of the core wire 22 are joined. Further, joining may be performed in a state where the longitudinal direction of the electric wire 20 crosses the longitudinal direction of the terminal 10. Therefore, as in the first embodiment, it is possible to provide the joining method of the terminal-equipped electric wire with enhanced degree of freedom in assembling because the electric wire extending direction is not limited.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A terminal-equipped electric wire formed by joining a terminal and a core wire exposed from an insulation sheath of an electric wire by method of ultrasonic joining, wherein
the terminal includes a joining portion having a square shape or a round shape in plan view, to which a distal end portion of the core wire is joined, and
when the joining portion has a square shape, a longitudinal direction of the electric wire is orthogonal to a longitudinal direction of the terminal.

2. The terminal-equipped electric wire according to claim 1, wherein
when the joining portion has a square shape, a joining width of the core wire is smaller than a width of the joining portion.

3. The terminal-equipped electric wire according to claim 1, wherein
when the joining portion has a round shape, the longitudinal direction of the electric wire crosses the longitudinal direction of the terminal.

4. A joining method of a terminal-equipped electric wire, comprising:
joining a terminal and a core wire exposed from an insulation sheath of an electric wire by method of ultrasonic joining, wherein
the terminal includes a joining portion having a square shape or a round shape in plan view,
the joining portion and a distal end portion of the core wire are joined, and
when the joining portion has a square shape, joining is performed in a state where a longitudinal direction of the electric wire is orthogonal to a longitudinal direction of the terminal.

5. The joining method of the terminal-equipped electric wire according to claim 4, wherein
when the joining portion has a round shape, joining is performed in a state where the longitudinal direction of the electric wire crosses the longitudinal direction of the terminal.
